(19) United States
(12) Patent Application Publication
(10) Pub. No.: US 2007/0113853 A1
(43) Pub. Date: May 24, 2007

(54) BREATHING MASK, PARTICULARLY FOR SPORTS USE

(76) Inventor: Filippo PAVESI, Torino (IT)

Correspondence Address: SUGHRUE MION, PLLC, 2100 PENNSYLVANIA AVENUE, N.W., SUITE 800, WASHINGTON, DC, 20037, US

(21) Appl. No.: 11/561,939

(22) Filed: Nov. 21, 2006

(30) Foreign Application Priority Data
Nov. 23, 2005 (EP) 05425830.6

(51) Int. Cl. A62B 18/02

(52) U.S. Cl. 128/205.25; 128/207.11

(57) ABSTRACT

The breathing mask comprises an annular band of flexible material, suitable for encircling the neck and at least a lower portion of the head of a user, a shell connected to the band, its concavity towards the interior of the band, and suitable for defining a chamber able to accommodate the user's nose and mouth, and at least one tube extending from an opening formed in the shell to a region remote from the shell, in such a way that during use the user inhales air from the said region through the said tube.

### DESCRIPTION

The present invention relates to a breathing mask, particularly for use in sports.

It is an object of the invention to provide a breathing mask that will protect the nose, the mouth and the initial airways when engaged in various sports activities in cold climates, yet allow easy breathing.

These and other objects are achieved according to the invention with a breathing mask which in accordance with a more general concept comprises
an annular band of flexible material, suitable for encircling the neck and at least the lower portion of the head of a user,
a shell connected to the band, with its concavity turned towards the interior of the band, and suitable for defining a chamber able to accommodate the user's nose and mouth, and
at least one tube extending from an opening formed in the said shell to a region remote from the shell, in such a way that during use the user inhales air from the said region through the said tube.

Other features and advantages of the invention, and many different embodiments thereof, will be shown in the following detailed description, given purely by way of non-restrictive example, with reference to the accompanying drawings, in which:

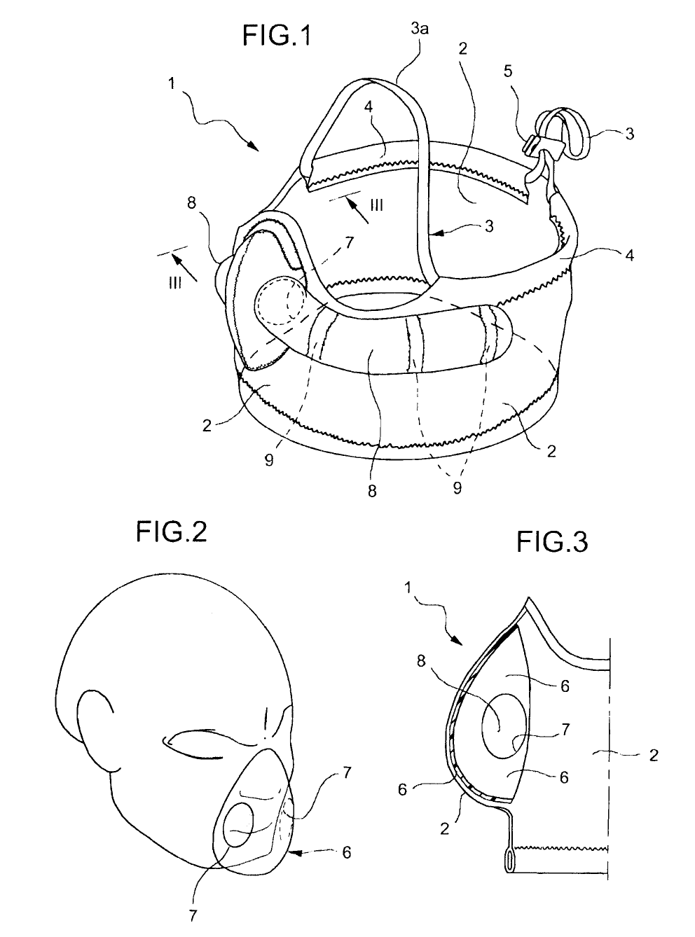

FIG. 1 is a perspective view of a breathing mask according to the invention;

FIG. 2 is a perspective view showing a shell for a mask according to the invention applied around the nose and mouth of a user;

FIG. 3 is a partial view in section on the plane marked III-III in FIG. 1;

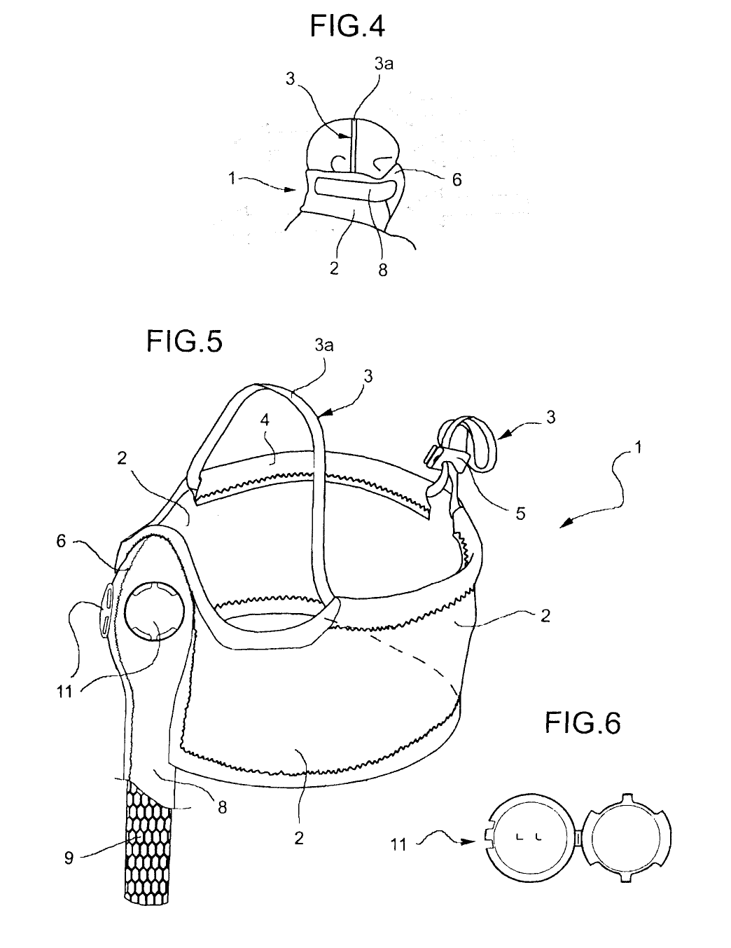

FIG. 4 is a side view of a breathing mask as shown in FIG. 1 as worn by a user;

FIG. 5 is a perspective view of another embodiment of a breathing mask according to the invention;

FIG. 6 shows a valve device for the breathing mask of FIG. 5;

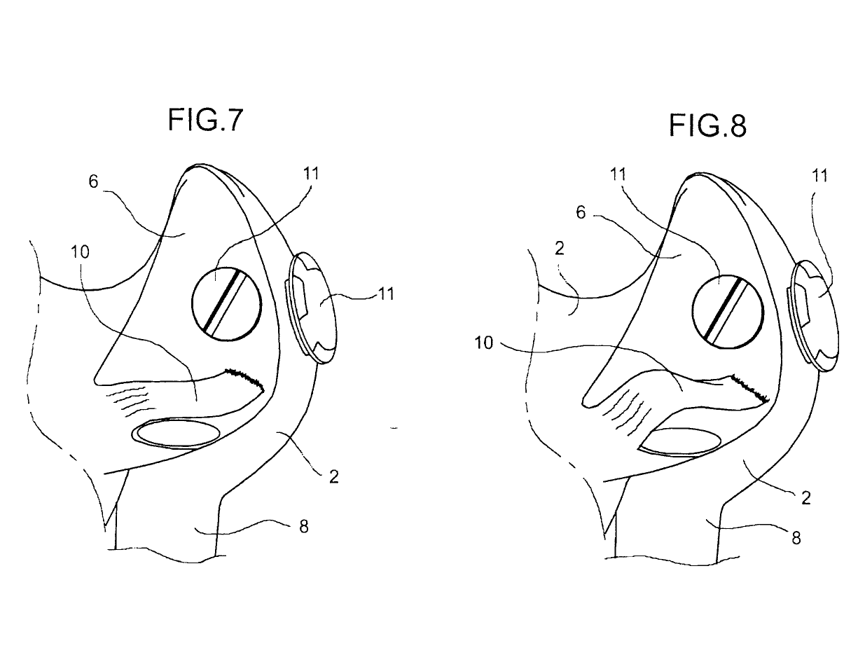

FIGS. 7 and 8 are partial views, partly sectioned, showing two different conditions of operation of a valve device inside the breathing mask of FIG. 5;

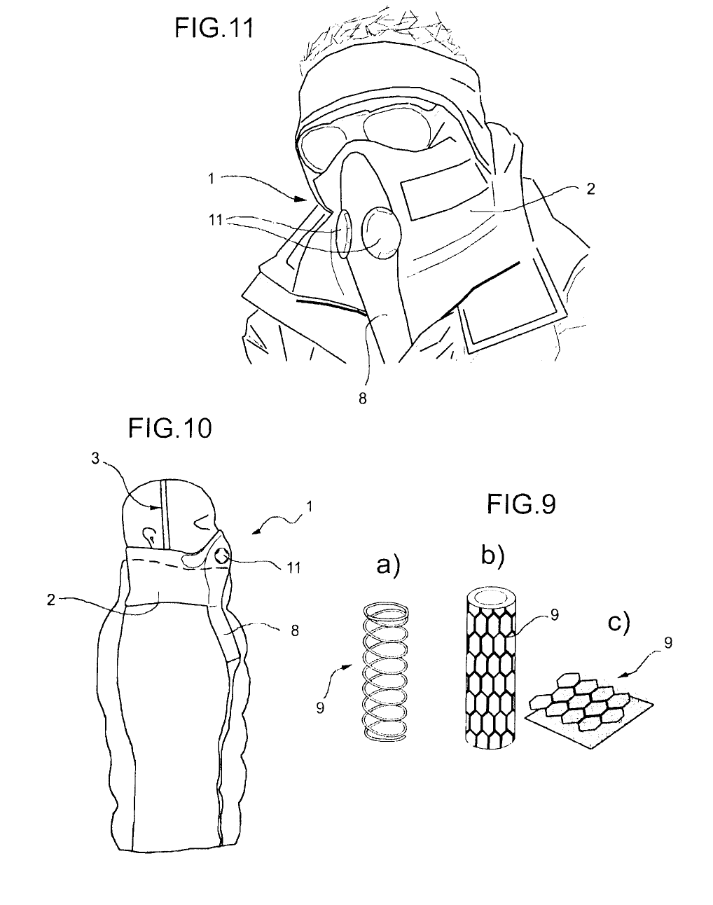

FIGS. 9(a), (b) and (c) show three embodiments of stiffening structures for a tubular appendage or proboscis for the breathing mask of FIG. 5;

FIG. 10 is a diagrammatic partial view of a mask in accordance with FIG. 5 in a condition of use;

FIG. 11 is a front view of a mask in accordance with FIG. 5 as worn by a user;

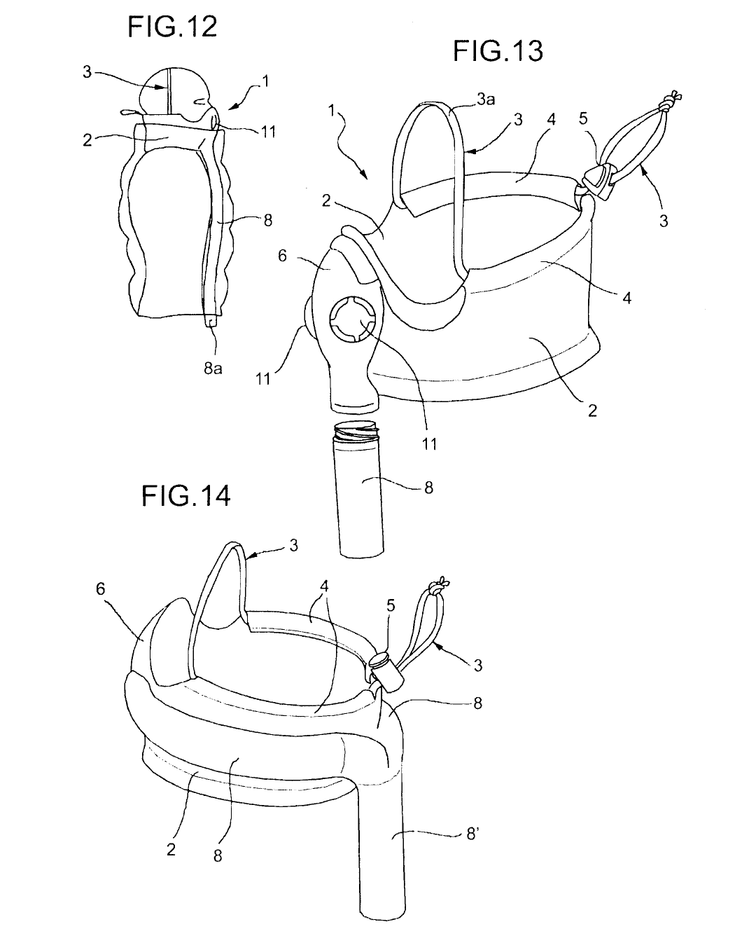

FIG. 12 is a view similar to that given in FIG. 10, and shows a variant of the breathing mask of FIG. 5;

FIG. 13 is a perspective view of another variant of the breathing mask of FIG. 5; and

FIG. 14 is a perspective view of another variant.

In FIG. 1 the numeral 1 is a general reference for a breathing mask according to the invention.

The mask 1 comprises an annular band 2 of flexible material, its dimensions enabling it to encircle the neck and at least the lower part of the head of the user, covering the nose and mouth in particular. The band 2 may optionally extend sufficiently to also cover the user's ears, or may be incorporated into a head covering or so-called “balaclava”.

The band 2 may be made of woven or nonwoven materials, preferably thermally insulating, lightweight, wind-resistant, at least partly breathable, and optionally elastic or elasticated. Examples of suitable materials are for instance the materials marketed under the registered trade marks Polartec, Powershield, Windpro and Windbloc, all produced by the United States company Malden Mills, or under the registered trade marks GoreTex or Windstopper, both produced by the United States company W. L. Gore.

Although with a suitable design and the adoption of elastic or elasticated materials the band 2 can easily be adapted to the characteristics of different users, some means of adjustment may conveniently be provided, such as a drawcord 3 in tunnels 4 near the upper edge of the band. In the illustrative embodiment shown in FIG. 1 the drawcord 3 forms a main loop 3a designed to pass over the head of a user (see FIG. 4). At the back of the band 2 the part of the drawcord 3 that emerges from the tunnels 4 is provided with a cord stop device 5 of a sort known per se.

A particular feature of the version described above is that it prevents the mask slipping down the user's head during more intense sporting activities.

Attached to the inside of the front part of the band 2 is a shell 6 (FIGS. 2 and 3) of a material which by comparison is slightly stiffer. The concavity of this shell 6 is turned towards the interior of the band and its dimensions are such that it is able to accommodate the user's nose and mouth, as indicated in FIG. 2.

In the illustrative embodiment described, the shell 6 has two approximately circular side openings 7. These openings are connected to the ends of corresponding tubes 8 which run in opposite, essentially horizontal directions towards the back of the band 2, which is intended when in use to cover the nape of the neck of the user.

The radius of the cross section of the tubes 8 may be for example between 20 and 50 mm. They can be made of various types of plastic or elastomeric materials, or conceivably even from the same woven or nonwoven materials as the band 2.

The shell 6 and the tubes 8 may conveniently be made in one piece.

If the tubes 8 are not made of a sufficiently stiff material, they must be strengthened with an internal, preferably elastic and flexible structure to keep them open. Such a support structure, in the form of for example a plurality of rings 9 incorporated in the tube (FIG. 1), may be produced from various types of plastic materials such as nylon, Hytrel (registered trade mark) or Lexan (registered trade mark). In place of a plurality of rings, the structure designed to keep the tubes 8 open may comprise multiple flexible “sticks” inserted into corresponding pockets in the walls of the tubes 8, at right angles to the direction of these tubes.

An alternative way of keeping the tubes 8 open is to insert a “core” of a semi-rigid three-dimensional textile material, such as the material known as “3D-mesh”, the dimensions of the meshes or cells of which must be such as to allow the passage of a substantial flow of air through the abovementioned tubes.

As mentioned earlier, the tubes 8 are long enough to extend to the sides of the face, to below the ears, or even as far as the nape of the neck of the user. Their length may typically be between 50 and 250 mm.

The wall of the band 2 that covers the front of the shell 6 may optionally comprise one or more additional layers of insulating textile materials, in order to reduce the temperature bridge between the region inside the shell 6 and the external environment and so reduce the formation of condensation in this shell. Examples of materials suitable for this purpose are those marketed under the registered trade marks Polartec Classic and Polartec Thermal Pro, both produced by Malden Mills (USA).

It is useful to have the upper edge of the mask 1, in particular the front, shaped to cover the nose without obstructing the vision. The shaping of this edge must be compatible with the use of protective goggles. The front of the mask around the upper portion of the edge of the shell 6 may incorporate plates or sticks of metallic materials or shape-memory polymeric materials that can be moulded to the shape of the user's nose in order to get a better seal between the mask and the perinasal region of the user. This will also prevent fogging of goggles, if worn by the user. Alternatively, the front portion of the mask 2 may incorporate, for the same reasons, a sheet of shape-memory polymer material, in solid or expanded form, capable of moulding itself under the effect of the temperature of the body, and thereafter capable of retaining the impression of the user's face.

The breathing mask described above is particularly indicated for use in sports such as racing, skating, cross-country skiing and downhill skiing, snowboarding, cycling and motorcycling, especially in their winter forms.

With reference to FIG. 4, the use of the mask gives efficient frontal wind protection and allows the user to breath only “calm”, partially preheated air.

The version described, which uses a single cord pull 3 is particularly practical because it can be used for both height and width adjustment.

FIGS. 5 to 10 illustrate a variant of a breathing mask according to the invention. In these figures, parts and elements already described in relation to FIGS. 1-4 have again been given the same reference numbers as used previously.

With reference to FIG. 5, the breathing mask 1 illustrated here again comprises a band 2 of flexible material designed to encircle the neck and at least the lower part of the head of a user.

The mask in FIG. 5 differs from that in the preceding figures essentially in that the front portion of the band 2, which contains the shell designed to fit over the nose and mouth, possesses a single tubular appendage or tube 8 which is conveniently turned downwards. The points made earlier in relation to the tubes 8 of the mask shown in FIG. 1 also apply to this “proboscis”. The tube or proboscis 8 of the mask shown in FIG. 5 can therefore similarly be made from various types of plastic or elastomeric materials, or from the same woven or nonwoven materials used for the band 2. In the case of insufficiently stiff materials, the proboscis 8 must be supported by an internal, preferably elastic and flexible core such as to prevent it from collapsing and closing up. This core, marked 9 in FIG. 5, can be made from various types of plastic or elastomeric materials, and in various shapes. A number of examples of embodiments are shown in FIGS. 9(a) (spiral element), 9(b) (tubular element with cellular walls of e.g. 3D-mesh) and 9(c) (a sheet of “3D-mesh” to be applied to the inside surface of the material forming the proboscis).

With reference to FIGS. 10 and 11, the proboscis 8 of the mask shown in FIG. 5 is long enough to extend into the region of the user's chest, a length of for example between 150 and 300 mm. In use, the proboscis 8 is passed down inside an outer garment (a jacket or the like), as shown diagrammatically in FIG. 10, in such a way that when in use it enables the user to inhale relatively warm, moist air, certainly warmer than the surrounding air in the cold seasons.

Conveniently, the inside of the front of the mask 1, as shown in FIGS. 7 and 8 at the entrance to the tube or proboscis 8, is provided with a flexible flap 10 capable of acting as a one-way valve element. Basically, the flap 10 uncovers the entrance to the proboscis 8 during inhalation, allowing the admission of relatively warm, moist aspirated air into the mask. The flap 10 then closes the entrance to the proboscis 8 during exhalation.

The shell 6 and its outer covering 2 conveniently contain one or two openings to which are fitted corresponding one-way valves 11 to allow the expulsion of air with a high carbon dioxide content in each breathing phase.

The valves 11 may be made from various types of plastic or elastomeric materials or conceivably from the same woven or nonwoven materials from which the band 2 of the mask is made. Their diameter may be for example 15-20 mm.

If made of plastic, the valves 11 may include an internal elastomeric membrane.

In other respects, the same points as made earlier in relation to the breathing mask of FIGS. 1 to 4 also apply to the mask of FIGS. 5 to 11, particularly in relation to the materials that can be used for its various constituent parts.

A mask as shown in FIGS. 5 to 11 is particularly indicated when engaging in sports in very cold climates. It conveys to the primary airways preheated air from areas of the body that are covered with thermally insulating garments, and enables the exhaled carbon dioxide to be expelled to the exterior.

FIG. 12 shows a variant of the breathing mask of FIGS. 5-11.

In the breathing mask seen in FIG. 12, the proboscis 8 is of a length that enables it to extend under the outer garment as far as the region of the user's waist, and its distal end 8a passes out of the garment to draw air from the surrounding environment. This air is at least partially preheated inside the proboscis 8 before reaching the respiratory apparatus of the user.

In the variant shown in FIG. 13, the proboscis 8 can be connected to and disconnected from the rest of the mask 1 by means of a reversible connection such as a threaded connection.

Lastly, FIG. 14 shows another variant in which the mask has two tubes 8 that extend from the front region, around the sides of the band 2, to the rear portion of this band which is designed to cover the nape of the neck. At this rear portion of the band 2, the two tubes 8 come together in a single tube 8′ which leads downwards and is intended to be inserted underneath at least one outer garment, in order to convey preheated air from the user's dorsal region to his airways.

In the embodiments with the proboscis, in other words the variants illustrated in FIG. 5 onwards, if the shell 6 and the associated proboscis 8 are stiff enough the masks in these embodiments ensure that the user has a certain respiratory capacity if buried in a landslide or avalanche, this capacity deriving from the reserve of air which is preserved between the body of the user and his garments in such an eventuality.

In alternative embodiments (not shown), a mask according to the invention may comprise a portion including the shell 6 and the associated tubes 8 or the associated single tube 8, with connecting means (e.g. press studs or microhook-type connecting elements) for connecting it to the lower/rear portion of a head covering. This portion, which includes the shell 6, can be connected to the head covering along essentially vertical connecting lines. As an alternative, the said portion of the mask may be an annular band suitable for encircling the user's neck and able to be connected to the lower/rear border of a head covering, along an essentially horizontal connecting line.

Clearly, provided the principle of the innovation is retained, the forms of embodiment and the details of manufacture may vary greatly from what has been described and illustrated purely by way of non-restrictive example, without thereby departing from the scope of the invention as defined in the accompanying claims.

What is claimed is:

1. A breathing mask, particularly for sports use, comprising
an annular band of flexible material, suitable for encircling the neck and at least a lower portion of the head of a user,
a shell connected to the band, its concavity towards the interior of the said band, and suitable for defining a chamber able to accommodate the user's nose and mouth, and
at least one tube extending from an opening formed in the said shell to a region remote from the shell, in such a way that during use the user inhales air from the said region through the said tube.

2. A breathing mask according to claim 1, in which the band is also suitable for covering the user's ears.

3. A breathing mask according to claim 1, in which the band is incorporated into a head covering such as a so-called balaclava.

4. A breathing mask according to claim 1, in which the said annular band is provided with connecting means suitable for connecting it to the lower/rear portion of a head covering.

5. A breathing mask according to claim 1, in which the band is provided with at least one cord element suitable for forming at least one upper loop so that it can pass over the head of the user, following an essentially meridian line.

6. A breathing mask according to claim 5, in which the said cord element is provided with a cord stop device for fastening it in a tightened condition on the user's head.

7. A breathing mask according to claim 1, in which the said shell has two openings from which there extend in opposite directions respective tubes running in an essentially horizontal direction and attached to the outer surface of the band.

8. A breathing mask according to claim 1, in which the said shell has a main opening from which there extends a downward tubular appendage or proboscis defining a tube for the passage of inhaled air.

9. A breathing mask according to claim 1, in which the said tubes extend as far as the rear part of the band, where they come together in a single downward tubular appendage.

10. A breathing mask according to claim 8, in which the shell has at least one opening provided with a one-way valve to allow the escape of exhaled air.

11. A breathing mask according to claim 8, in which the end of the said tubular appendage or proboscis adjacent to the said shell is provided with a one-way valve suitable for allowing air to be admitted on each inhalation from the said appendage or proboscis to the chamber defined in the said shell.

12. A breathing mask according to claim 8, in which the said tubular appendage or proboscis is long enough to be inserted beneath a garment, such as a jacket or the like, worn by the user.

13. A breathing mask according to claim 12, in which the said tubular appendage or proboscis has a length such that its distal end extends into the region of the user's waist.

14. A breathing mask according to claim 8, in which the said tubular appendage or proboscis is detachably connected to the mask.

15. A breathing mask according to claim 1, in which the said tube or tubes are provided with reinforcing means suitable for preventing them from collapsing and for keeping them open.

16. A breathing mask according to claim 1, the front portion of which is provided with one or more elements made from a shape-memory material.

17. A breathing mask according to claim 1, in which the shell and the said tube or tubes are made in one piece.
